(19) United States
(12) Patent Application Publication
(10) Pub. No.: US 2007/0193991 A1
(43) Pub. Date: Aug. 23, 2007

(54) Method of soldering wiring members by laser beam irradiation

(75) Inventors: Masashi Yamasaki, Nagoya-city (JP); Mutsumi Yoshino, Nagoya-city (JP); Yasunori Kawamoto, Toyota-city (JP)

Correspondence Address: POSZ LAW GROUP, PLC, 12040 SOUTH LAKES DRIVE, SUITE 101, RESTON, VA, 20191, US

(73) Assignee: DENSO CORPORATION, Kariya-city (JP)

(21) Appl. No.: 11/640,939

(22) Filed: Dec. 19, 2006

(30) Foreign Application Priority Data
Feb. 23, 2006 (JP) 2006-47035

(51) Int. Cl. B23K 1/005

(52) U.S. Cl. 219/121.85

(57) ABSTRACT

Wiring members such as bus bars for electrically connecting electronic components are contained in a casing composed of a substrate and a cover for closing an opening of the substrate. A laser beam is irradiated on and around solder held in one of the wiring members through a laser-transparent portion formed in the cover of the casing. The solder is melted by energy of the laser beam, and the wiring members are electrically connected by the molten solder. The electronic components and wiring members may be encapsulated in the casing before or after the laser beam is irradiated. Since the laser beam is irradiated from outside the casing after the electronic components and wiring members are contained in the casing, they can be positioned in the casing with greater freedom.

### CROSS-REFERENCE TO RELATED APPLICATION

This application is based upon and claims benefit of priority of Japanese Patent Application No. 2006-47035 filed on Feb. 23, 2006, the content of which is incorporated herein by reference.

### BACKGROUND OF THE INVENTION

1. Field of the Invention

The present invention relates to a method of soldering wiring members such as bus bars by irradiating a laser beam.

2. Description of Related Art

Some examples of technologies for connecting wiring members by irradiating a laser beam are disclosed in the following patent publications: (1) JP-A-2005-123366, (2) JP-A-2005-101473, (3) JP-A-2005-72612, (4) JP-A-5-13946 and (5) JP-A-2003-266543. Publication (1) proposes to weld metal foils on a flexible substrate by a laser beam; publication (2) proposes a soldering method by using a laser beam; publication (3) discloses a method of connecting chips to a wiring member on a substrate by melting a solder bump on a front surface of the substrate by irradiating a laser beam from a rear surface of the substrate; publication (4) proposes a method of soldering terminals of electronic components by using a laser beam; and publication (5) discloses a method of connecting a laser-transparent resin cover to a laser-absorbing case by irradiating a laser beam.

Generally, an electronic circuit device is encapsulated in a casing for waterproof after all components are electrically connected by soldering. A substrate on which electronic circuits are mounted is covered with a cup-shaped cover. The cup-shaped cover is connected to the substrate after a soldering process is completed. In this case, however, it is difficult to mount a connector or a circuit on the cover. That is, it is difficult to electrically connect wiring members fixed on the cover to wiring members fixed on the substrate. If it is possible to electrically connect, by soldering, the components mounted on the substrate to a wiring member or components mounted on the cover after the cover is connected to the substrate, there would be many advantages. In the conventional technologies shown in the above publications, however, no concrete method to realize such is disclosed.

### SUMMARY OF THE INVENTION

The present invention has been made in view of the above-mentioned problem, and an object of the present invention is to provide an improved method for soldering wiring members by a laser beam.

First and second wiring members such as elongated bus bars are prepared, and both wiring members are overlapped on each other. The wiring members are contained in a casing composed of a substrate, on which electronic components and circuits are supported, and a cover having a laser-transparent portion. The first wiring member includes a hole in which solder is contained. A laser beam is irradiated on a laser-irradiating surface around the solder-holding hole through the laser-transparent portion of the cover. The solder contained in the solder-holding hole is melted and the molten solder flows between the overlapped wiring members. Thus, the wiring members are connected to each other by soldering.

The laser beam may be irradiated after the casing is closed with the cover having the laser-transparent portion. The laser-transparent portion may be composed of one or more open windows, or a portion made of laser-transparent thin resin. The open window (or windows) may be closed after the laser irradiating process is completed, or it may be used as a hole for optically inspecting a soldered state of the wiring members. The open window may be used as a ventilation or exhaust hole for ventilating gas generated in the casing in the soldering process. The laser-irradiating surface on the wiring members may be covered with a laser-absorbing film or may be made rough for effectively absorbing laser energy. The laser-irradiating surface may be separated from other spaces in the casing with a cylindrical wall connected to the cover to prevent gas generated in the solder-melting process from being dispersed.

An electronic component such as a connector may be fixed to the laser-transparent cover, and a terminal wire led out from the electronic component may be inserted into a through-hole formed in the substrate. A solid solder bump is formed in a vicinity of the through-hole, and the laser beam is irradiated through the laser-transparent cover on and around the solder bump so that the terminal wire is soldered to a conductor in the substrate.

According to the present invention, the laser beam is irradiated from an outside of the casing after electronic components and wiring members are contained in the casing. Accordingly, the electronic components and the wiring members are positioned in the casing with greater freedom. For instance, an electronic component such as a connector may be fixed to the cover instead of the substrate. Other objects and features of the present invention will become more readily apparent from a better understanding of the preferred embodiments described below with reference to the following drawings.

### BRIEF DESCRIPTION OF THE DRAWINGS

FIG. 1 is a cross-sectional view showing a first bus bar and a second bus bar to be connected by laser beam irradiation, as a first embodiment of the present invention, showing an instant a laser beam is irradiated;

FIG. 2 is a cross-sectional view showing the same bus bars as in FIG. 1, showing a state after soldering by laser beam radiation is completed;

FIG. 3 (a) and (b) show an example of a shape of the first and the second bus bars in a plan view;

FIG. 4 is a cross-sectional view showing the bus bars on which a laser-absorbing film is formed;

FIG. 5 is a cross-sectional view showing a modified form of a cover through which the laser beam is irradiated;

FIG. 6 is a cross-sectional view showing another modified form of a cover through which the laser beam is irradiated;

FIG. 7 is a cross-sectional view showing bus bars to be connected and a cover having laser windows through which a laser beam is irradiated;

FIG. 8 is a cross-sectional view showing a modified form of the cover having a single laser window through which the laser beam is irradiated on the bus bars;

FIG. 9 is across-sectional view showing another modified form of the cover having a convex lens through which the laser beam is irradiated;

FIG. 10 is a cross-sectional view showing a modified form of the cover having a cylindrical wall through which the laser beam is irradiated on the bus bars;

FIG. 11 is a cross-sectional view showing the cover having the cylindrical wall, an opening of which is closed with a cap;

FIG. 12 is a cross-sectional view showing a cover similar to that shown in FIG. 11, an opening of which is closed with a laser-transparent portion;

FIG. 13 is a cross-sectional view showing a cover on which an electronic component is mounted and a substrate on which a laser beam is irradiated, as a second embodiment of the present invention, showing an instant the laser beam is irradiated;

FIG. 14 is a plan view partially showing the substrate shown in FIG. 13, on which a solder bump is formed;

FIG. 15 is a cross-sectional view showing the same view as shown in FIG. 13, showing a state after a laser beam irradiating process is completed; and

FIG. 16 is a plan view showing the same view as shown in FIG. 14, the solder being spread around a terminal after the laser beam irradiation.

### DETAILED DESCRIPTION OF THE PREFERRED EMBODIMENTS

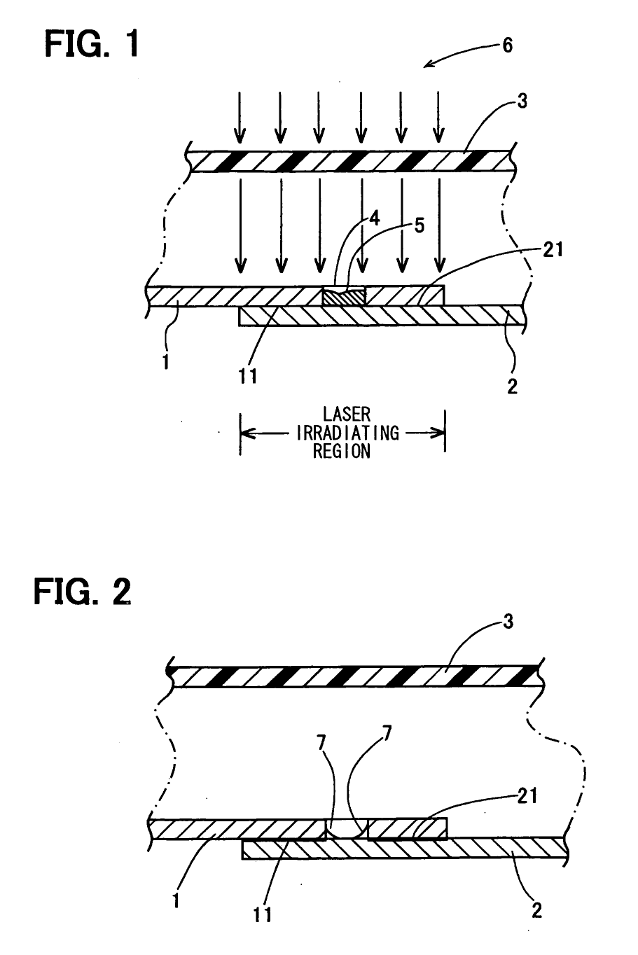

A first embodiment of the present invention will be described with reference to FIGS. 1 and 2. A first bus bar 1 and a second bus bar 2 (forming wiring members) are overlapped, and a cover 3 made of a laser-transparent resin is positioned above the bus bars to cover the bus bars. The bus bar 1 is made of copper and fixed to a substrate or a heat sink (not shown) which is positioned below the first bus bar 1 in parallel thereto. The second bus bar 2 is made of copper and fixed to the cover. Both bus bars 1, 2 are elongated and overlapped on each other, so that their contacting surfaces 11, 21 contact each other, as shown in FIG. 1.

The first bus bar 1 has a solder-holding hole 4 passing through an entire thickness of the bus bar 1. Solid solder 5 is disposed in the hole 4, a lower opening of which is closed by the second bus bar 2. The substrate on which a circuit device is disposed has an upper opening (not shown) which is closed by the cover 3. The substrate constitutes a casing together with the cover 3, and the circuit device is encapsulated in the casing. A connector (not shown) is fixed to the cover 3, and the second bus bar 2 reaches the connector. The first bus bar 1 reaches the circuit device (not shown) mounted on the substrate. The laser beam 6 is irradiated on the solder-holding hole 4 and its vicinity.

By irradiating the laser beam 6, the solid solder 5 in the solder-holding hole 4 is melted, and the molten solder permeates into a very small space between contacting surfaces 11, 21 by a capillary action. The molten solder is cooled down, and the bus bars 1, 2 are connected to each other by the solder. Solder fillets 7 are formed around a bottom corner of the solder-holding hole 5, as shown in FIG. 2.

The laser beam may be irradiated after the opening of the substrate is closed by connecting the cover 3, or the cover 3 may be connected to the substrate after the soldering process is completed by irradiating the laser beam. A portion of the cover 3 that corresponds to a laser-irradiating region (shown in FIG. 1) may be made laser-transparent, instead of making an entire cover 3 laser-transparent. Components other than the connector may be fixed to the cover 3.

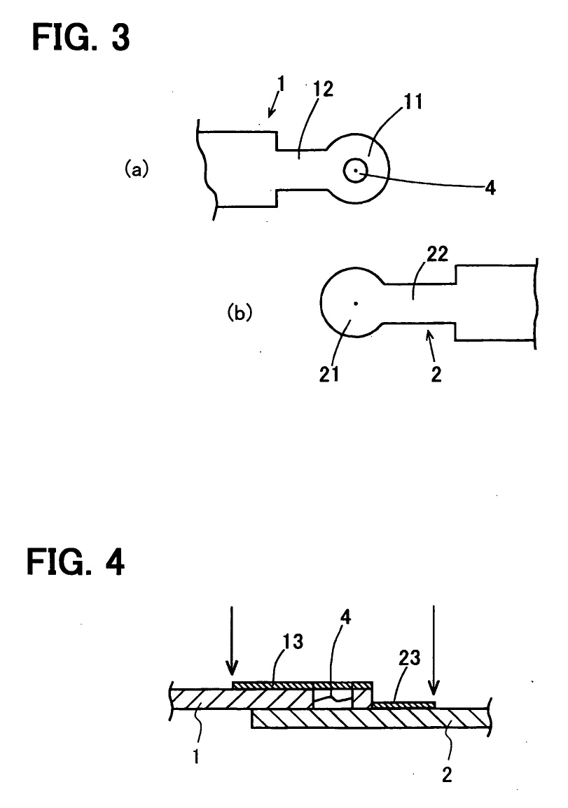

The first embodiment described above may be variously modified. Some examples of modifications are shown in FIGS. 3-12. In FIG. 3, an example of the shape of the connecting surfaces 11, 21 of the bus bars 1, 2 is shown. The solder-holding hole 4 is formed at the center portion of the round connecting surface 11, as shown in FIG. 3(a). A round connecting surface 11 of the first bus bar 1 is bridged to a main portion of the bus bar 1 via a narrowed portion 12. Similarly, a round connecting surface 21 of the second bus bar 2 is bridged to its main portion via a narrowed portion 22, as shown in FIG. 3(b). By making the narrowed portions 12, 22, heat transfer from the connecting surfaces 11, 21 to the main bodies of the bus bars 1, 2 is alleviated.

FIG. 4 shows an example of bus bars 1, 2, on which laser-absorbing films 13, 23 are formed. The laser-absorbing films 13, 23 are formed to cover the laser-irradiating region to increase a laser energy density in that region. The laser-absorbing films 13, 23 may be formed by black resin paint or a dark plated film. Alternatively, in place of the laser-absorbing films, the surface may be made rough to effectively absorb the laser energy.

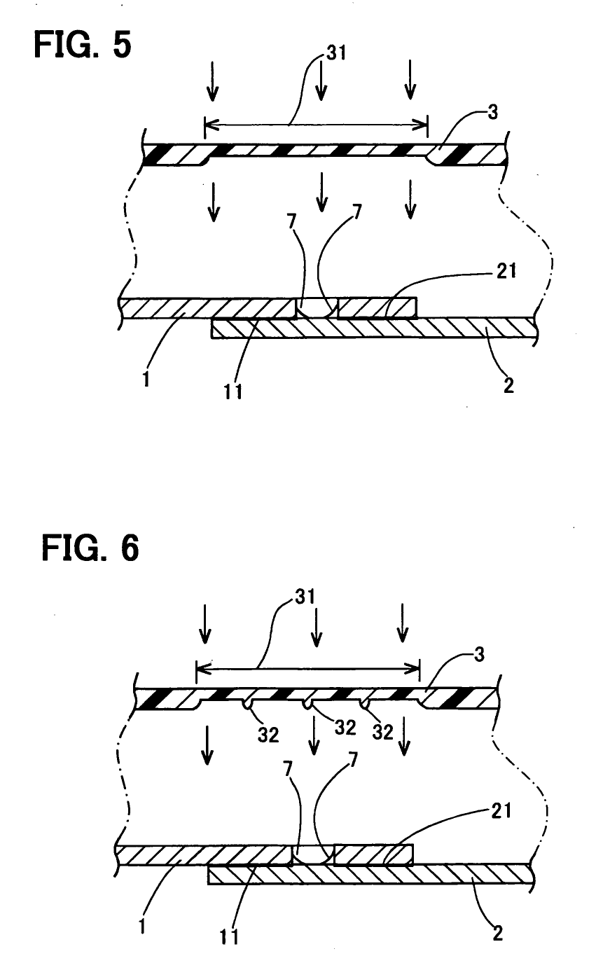

FIG. 5 shows an example of a modified form of the cover 3. A portion of the cover 3 corresponding to the laser-irradiating region is made thin, forming a laser-transparent portion 31. In this manner, damages on the cover 3 due to heat generated by the laser irradiation can be avoided. As shown in FIG. 6, projected beams may be formed on the laser-transparent portion 31 in a lattice arrangement. In this manner, a mechanical strength of the laser-transparent portion 31 is increased.

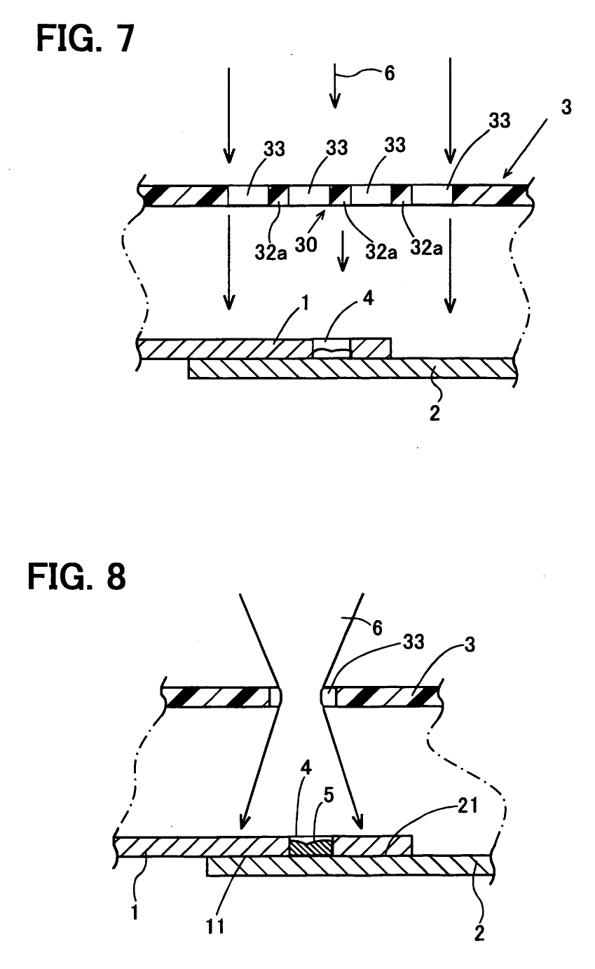

FIG. 7 shows an example of a modified form of the cover 3. The cover 3 includes plural square laser windows (openings) 33 separated by frames 32a. In this manner, heat damages on the cover 3 are alleviated. Though the laser beam is irradiated on the frames 32a, the frames 32a are not easily damaged because their relative surface area is large and the laser heat is effectively dissipated. The frames 32a may be made of materials other than the material forming the cover 3. For instance, the frames 32a may be made of metallic materials. Preferably, the laser windows 33 are closed after the soldering process by laser irradiation is completed. The frames 32a may be utilized for closing the laser windows 33.

FIG. 8 shows another modified form of the cover 3. In this modified form, the cover 3 has a single laser window 33 where the laser beam 6 is focused. The laser-irradiating region on the first bus bar 1 can be made larger than an area of the laser window 33. Damages on the cover 3 due to laser beam can be avoided at the same time. The laser window 33 may be used as a hole for inserting an endoscope. Conditions of the solder in the solder-holding hole 4 are inspected by the endoscope after the soldering process is completed. After the inspection, it is preferable to close the laser window 33 in various manner, e.g., by using a device for connecting the cover 3 to the substrate containing the bus bars 1, 2.

Alternatively, the laser window 33 may be used as a ventilation hole by installing a GORE-TEX® therein. Further, the laser window 33 may be used as an exhaust hole for exhausting gas or smoke generated by melting the solder 5. It is preferable to form an inlet hole for introducing fresh air into the cover 3 in addition to the laser window 33 functioning as the exhaust hole. Further, an exhaust hole, an inspection hole, a ventilation hole and/or an inlet hole may be formed separately from the laser window 33. It is also possible to insert an exhaust pipe covering a vicinity of the solder-holding hole 4 through the laser window 33. Preferably, fresh air is introduced at the same time through another inlet hole or the laser window 33.

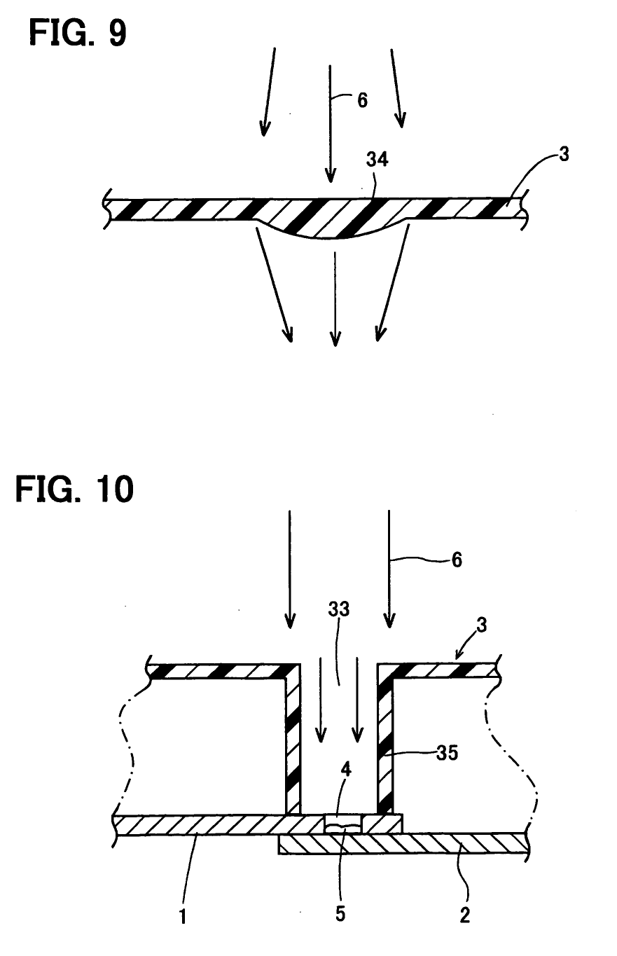

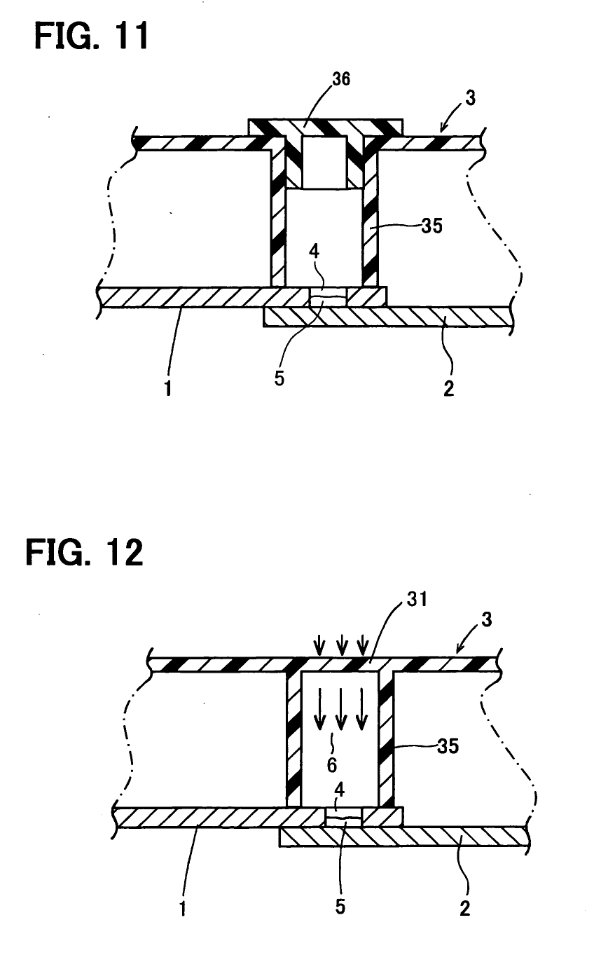

As shown in FIG. 9, the laser-transparent portion may be made in a form of a convex lens 34. The laser beam 6 can be irradiated on a desired area through the convex lens 34. As shown in FIG. 10, a cylindrical wall 35 for preventing gas and smoke generated in the soldering process from being dispersed in the casing may be connected to the cover 3. The cylindrical wall 35 also functions as a jig for securing a position of the first bus bar 1 relative to the second bus bar 2. The opening of the cylindrical wall 35 may be closed with a cap 36 after the soldering process is completed, as shown in FIG. 11. Further, as shown in FIG. 12, the opening of the cylindrical wall 35 may be replaced with a laser-transparent portion 31, through which the laser beam 6 is irradiated.

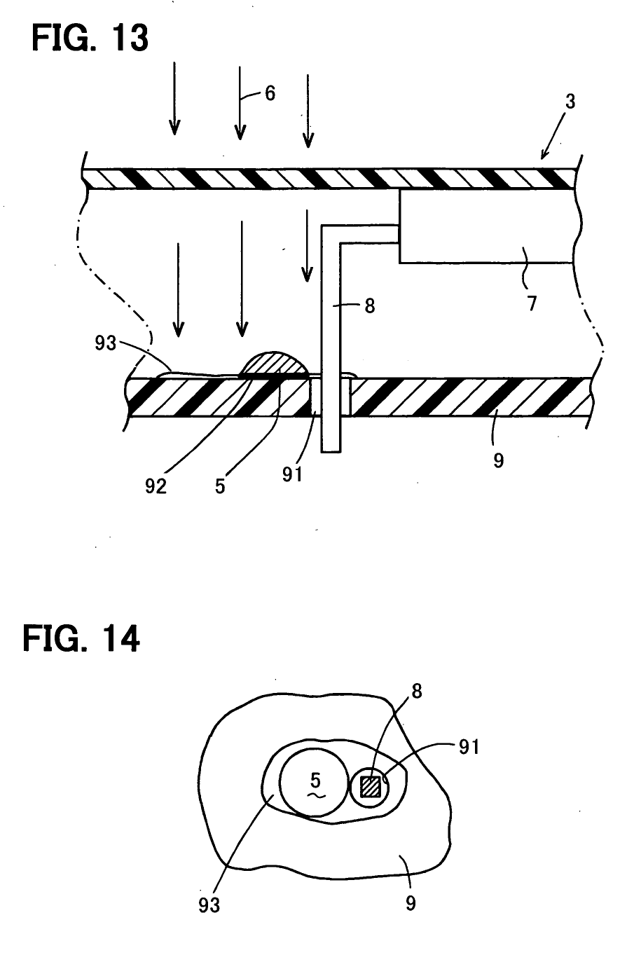

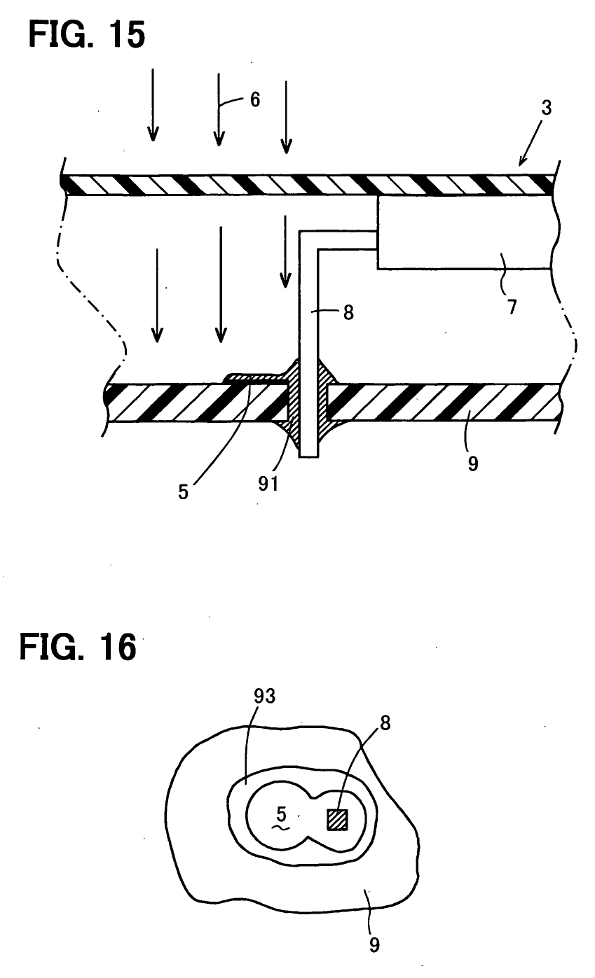

A second embodiment of the present invention will be described with reference to FIGS. 13-16. FIGS. 13 and 14 show an instant when the laser beam 6 is irradiated, and FIGS. 15 and 16 show a situation after the laser beam is irradiated. An electronic component (or a connector 7) is fixed to an inner surface of the cover 3, and a terminal 8 extending from the electronic component 7 is led to a through-hole 91 formed in a substrate 9. A conductor pattern as a first conductor member is formed in the substrate 9. Solder 5 is disposed on a circular rand 92 formed in a vicinity of the through-hole 91, and a laser-absorbing film 93 is formed around the circular rand 92. A conductor pattern may be formed under the laser-absorbing film 93. Preferably, the terminal 8 is inserted into the through-hole 91 after the solder 5 is disposed on the circular rand 92.

The laser beam 6 is irradiated on the laser-beam absorbing film 93 through the cover 3 to melt the solder 5 on the circular rand 92. The molten solder 5 flows into the through-hole 91 by gravity or surface tension, and thereby the terminal 8 is electrically connected to the conductor pattern formed in the substrate 9, as shown in FIG. 15. The solder 5 positioned on the circular rand 92 as shown in FIG. 14 spreads into and around the through-hole 91 as shown in FIG. 16. The solder 5 may be held in a hole or a depression formed on the substrate 9 in place of the circular rand 92. A bus bar may be used in place of the substrate 9.

Advantages attained in the present invention are summarized in that electronic components and the wiring members can be electrically connected by irradiating the laser beam from an outside of the casing after they are contained in the casing. Accordingly, the electronic components and wiring members are positioned in the casing with greater freedom.

While the present invention has been shown and described with reference to the foregoing preferred embodiments, it will be apparent to those skilled in the art that changes in form and detail may be made therein without departing from the scope of the invention as defined in the appended claims.

What is claimed is:

1. A method of soldering wiring members, comprising:
preparing a first elongated wiring member having a solder-holding hole passing through an entire thickness of the first wiring member;
overlapping the first elongated wiring member on a second elongated wiring member;
disposing holder in the solder-holding hole; and
irradiating a laser beam on the first wiring member in a vicinity of the solder-holding hole to melt the solder and to connect the first wiring member to the second wiring member.

2. The method of soldering wiring members as in claim 1, wherein:
the solder-holding hole is closed by a surface of the second wiring member at a side opposite to a direction from which the laser beam is irradiated.

3. The method of soldering wiring members as in claim 1, wherein:
a solder fillet is formed around a corner of the solder-holding hole on a surface of the second wiring member where the second wiring member contacts the first wiring member.

4. The method of soldering wiring members as in claim 1, wherein:
each of the first and the second wiring members includes a narrowed portion that alleviates heat transfer from a laser-irradiating region to a main body of the wiring members.

5. The method of soldering wiring members as in claim 1, wherein:
a laser-irradiating region of the wiring members, on which the laser beam is irradiated, has a higher laser-absorbing ability than other regions of the wiring members.

6. The method of soldering wiring members as in claim 5, wherein:
the laser-irradiating region is covered with a laser-absorbing film.

7. The method of soldering wiring members as in claim 5, wherein:
The laser-irradiating region has a rough surface.

8. The method of soldering wiring members as in claim 1, wherein:
the wiring members are substantially encapsulated in a casing having a laser-transparent portion, and the laser beam is irradiated from an outside of the casing through the laser-transparent portion.

9. The method of soldering wiring members as in claim 8, wherein:
the casing is composed of a cover having the laser-transparent portion and a substrate; and
the first wiring member is connected to the substrate and the second wiring member is connected to the cover.

10. The method of soldering wiring members as in claim 9, wherein:
the wiring members are encapsulated in the casing after the laser beam is irradiated.

11. The method of soldering wiring members as in claim 9, wherein:
the wiring members are encapsulated in the casing before the laser beam is irradiated.

12. The method of soldering wiring members as in claim 8, wherein:
the laser-transparent portion is made of a thin laser-transparent resin.

13. The method of soldering wiring members as in claim 8, wherein:
the laser-transparent portion is an open window through which the laser beam is irradiated.

14. The method of soldering wiring members as in claim 12, wherein:
the laser-transparent portion is a convex lens having an area larger than a laser-irradiating region on the wiring members.

15. The method of soldering wiring members as in claim 12, wherein:
the laser-transparent portion is thinner than other portions of the casing.

16. The method of soldering wiring members as in claim 15, wherein:
the laser-transparent portion is reinforced by projected beams.

17. The method of soldering wiring members as in claim 8, wherein:
the casing includes at least either one of a laser-transparent portion or an open window for optically inspecting a state of the molten solder after the laser beam irradiation is completed.

18. The method of soldering wiring members as in claim 17, wherein:
the open window for inspection is closed at the same time as the wiring members are encapsulated in the casing.

19. The method of soldering wiring members as in claim 17, wherein:
the open window for inspection is also used as a ventilation window for preventing water condensation in the casing.

20. The method of soldering wiring members as in claim 8, wherein:
the casing includes an exhaust hole for exhausting gas generated by irradiating the laser beam.

21. The method of soldering wiring members as in claim 20, wherein:
the exhaust hole is also used as an inspection hole for optically inspecting a state of molten solder.

22. The method of soldering wiring members as in claim 20, wherein:
the exhaust hole is also used as a ventilation hole for preventing water condensation in the casing.

23. The method of soldering wiring members as in claim 8, wherein:
the casing includes a cylindrical wall for preventing gas generated by irradiation of the laser beam from dispersing in the casing, the cylindrical wall extending from the laser-transparent portion to a vicinity of a laser-irradiating region on the wiring members.

24. The method of soldering wiring members as in claim 23, wherein:
the cylindrical wall extending from the laser-transparent portion of the casing reaches and contacts the laser-irradiating region on the wiring members.

25. A method of soldering wiring members, comprising:
preparing a first wiring member having a first contacting surface and a second wiring member having a second contacting surface, the first wiring member having a solder-holding hole passing through an entire thickness of the first wiring member;
overlapping the first wiring member on a second wiring member so that the first contacting surface contacts the second contacting surface;
disposing solder in the solder-holding hole;
containing the wiring members in a casing that is able to encapsulate the wiring members therein, the casing having a laser-transparent portion; and
irradiating a laser beam on a laser-irradiating region on the wiring members so that the solder disposed in the solder-holding hole is melted and the first contacting surface is connected to the second contacting surface by the molten solder.

26. The method of soldering wiring members as in claim 25, wherein:
the casing is composed of a cover having the laser-transparent portion and a substrate; and
the first wiring member is connected to the substrate and the second wiring member is connected to the cover.

27. The method of soldering wiring members as in claim 26, wherein:
the wiring members are encapsulated in the casing after the laser beam is irradiated.

28. The method of soldering wiring members as in claim 26, wherein:
the wiring members are encapsulated in the casing before the laser beam is irradiated.

29. The method of soldering wiring members as in claim 25, wherein:
the laser-transparent portion is made of a thin laser-transparent resin.

30. The method of soldering wiring members as in claim 25, wherein:
the laser-transparent portion is an open window through which the laser beam is irradiated.

31. The method of soldering wiring members as in claim 29, wherein:
the laser-transparent portion is a convex lens having an area larger than a laser-irradiating region on the wiring members.

32. The method of soldering wiring members as in claim 25, wherein:
the laser-transparent portion is thinner than other portions of the casing.

33. The method of soldering wiring members as in claim 29, wherein:
the laser-transparent portion is reinforced by projected beams.

34. The method of soldering wiring members as in claim 25, wherein:
the casing includes at least either one of a laser-transparent portion or an open window for optically inspecting a state of the molten solder after the laser beam irradiation is completed.

35. The method of soldering wiring members as in claim 34, wherein:
the open window for inspection is closed at the same time as the wiring members are encapsulated in the casing.

36. The method of soldering wiring members as in claim 34, wherein:
the open window for inspection is also used as a ventilation window for preventing water condensation in the closed casing.

37. The method of soldering wiring members as in claim 25, wherein:
the casing includes an exhaust hole for exhausting gas generated by irradiating the laser beam.

38. The method of soldering wiring members as in claim 37, wherein:
the exhaust hole is also used as an inspection hole for optically inspecting a state of molten solder.

39. The method of soldering wiring members as in claim 37, wherein:
the exhaust hole is also used as a ventilation hole for preventing water condensation in the closed casing.

40. The method of soldering wiring members as in claim 25, wherein:
the casing includes a cylindrical wall for preventing gas generated by irradiation of the laser beam from dispersing in the casing, the cylindrical wall extending from the laser-transparent portion to a vicinity of a laser-irradiating region on the wiring members.

41. The method of soldering wiring members as in claim 40, wherein:
the cylindrical wall extending from the laser-transparent portion of the casing reaches and contacts the laser-irradiating region on the wiring members.

42. The method of soldering wiring members as in claim 1, wherein:
the first wiring member and the second wiring member are bus bars.

43. The method of soldering wiring members as in claim 25, wherein:
the first wiring member and the second wiring member are bus bars.

44. A method of soldering wiring members, comprising:
preparing a first wiring member having a solder-holding portion and a through-hole formed in a vicinity of the solder-holding portion;
disposing solid solder on the solder-holding portion;
inserting a terminal wire, forming a second wiring member, of an electronic component into the through-hole; and
irradiating a laser beam on the solid solder and its vicinity so that the solid solder is melted and flows into the through-hole to thereby connect the second wiring member to the first wiring member by soldering.
